(19) United States
(12) Patent Application Publication
(10) Pub. No.: US 2023/0396009 A1
(43) Pub. Date: Dec. 7, 2023

(54) ELECTRICAL CONNECTOR AND CORROSION RESISTANCE TERMINAL THEREOF

(71) Applicant: Cheng Uei Precision Industry Co., LTD., New Taipei City (TW)

(72) Inventor: YUN WU, Dong-Guan City (CN)

(21) Appl. No.: 18/093,803

(22) Filed: Jan. 5, 2023

(30) Foreign Application Priority Data
Jun. 1, 2022 (CN) 202221363468.3

(51) Int. Cl. H01R 13/03; H01R 13/405; H01R 24/60; H01R 13/502

(52) U.S. Cl. CPC H01R 13/03; H01R 13/405; H01R 24/60; H01R 13/502

(57) ABSTRACT

An electrical connector includes an insulating housing and a terminal module. The terminal module is fastened in the insulating housing. The terminal module includes a plurality of corrosion resistance terminals. Each corrosion resistance terminal has a fastening portion. A front end of the fastening portion extends frontward to form a contacting portion. A rear end of the fastening portion defines a soldering portion. A surface of the contacting portion of each corrosion resistance terminal sequentially has a copper electroplating layer, a nickel-tungsten electroplating layer, a gold electroplating layer, a platinum alloy electroplating layer and a rhodium-ruthenium alloy electroplating layer from an inside to an outside. A surface of the fastening portion of each corrosion resistance terminal is covered with an electro-deposition coating.

### BACKGROUND OF THE INVENTION

### 1. Field of the Invention

The present invention generally relates to a connector, and more particularly to an electrical connector, and a corrosion resistance terminal of the electrical connector.

### 2. The Related Art

A function of a smart phone becomes more and more powerful, so the smart phone has more and more power consumption. When a user uses the smart phone, power of the smart phone is consumed fast in a long time use, so the smart phone frequently needs charging. A charging frequency of the electrical connector is increased, insertion and withdrawal times of the electrical connector are increased accordingly, so that contacting areas of terminals of the electrical connector are rubbed frequently. Furthermore, in an insertion and withdrawal process of the electrical connector, sweats of a human hand will be attached to the contacting areas of the terminals which are adjacent to an interface of the electrical connector, consequently, the contacting areas of the terminals are easily corroded, and base materials of the terminals are accelerated to be corroded on account of the contacting areas of the terminals are rubbed frequently.

In addition, non-contact areas of the terminals are adjacent to an inside of the electrical connector, a corrosion chance and a corrosion degree of the contacting areas of the electrical connector are relatively greater than a corrosion chance and a corrosion degree of the non-contact areas of the electrical connector. Nevertheless, in a current terminal plating process, an entire terminal is plated in most situations to save time. Different electroplating materials are chosen to plate the contacting areas and the non-contact areas in multi-layer plating ways, respectively. Thereby, a cost of the electrical connector is undoubtedly increased, and resources are wasted.

A conventional electrical connector includes an insulating body, a plurality of conduction terminals fixed to the insulating body, and a shielding shell fixed to an outside of the insulating body. Each conduction terminal is plated by an electroplating layer. The shielding shell surrounds the outside of the insulating body to form a docking cavity between the shielding shell and the outside of the insulating body. Each conduction terminal has a fastening portion fixed to the insulating body, a contacting portion extended frontward from a front end of the fastening portion and projecting into the docking cavity, and a soldering portion extending beyond a rear surface of the insulating body. The electroplating layer of each conduction terminal at least includes a bottom layer, a platinum layer or a platinum alloy layer, and a rhodium layer or a rhodium-ruthenium alloy layer, so a corrosion resistance performance of each conduction terminal is able to be improved. At the same time, the bottom layer is disposed to be beneficial for increasing a bonding strength between the platinum layer or the platinum alloy layer and the bottom layer.

However, the above-mentioned conduction terminal of the conventional electrical connector with a corrosion resistance performance has six electroplating layers, so a cost of the conventional electrical connector is higher. The corrosion resistance performance of the six electroplating layers of the conventional electrical connector lasts for shorter time. Moreover, a non-contact area of each conduction terminal which is the fastening portion of each conduction terminal is without a corrosion resistance layer, so that a base material corrosion of each conduction terminal is easily accelerated.

Thus, it is essential to provide an innovative electrical connector with a corrosion resistance performance. The electrical connector improves the corrosion resistance performance of a contacting portion of each corrosion resistance conduction terminal of the electrical connector. The corrosion resistance performance of the contacting portion of each corrosion resistance conduction terminal of the electrical connector lasts for longer time and has a lower cost. A non-contact area of each corrosion resistance conduction terminal which is a fastening portion of each corrosion resistance conduction terminal of the electrical connector also has a corrosion resistance layer with the corrosion resistance performance, and the electrical connector includes the corrosion resistance conduction terminal.

### SUMMARY OF THE INVENTION

An object of the present invention is to provide an electrical connector. The electrical connector includes an insulating housing and a terminal module. The terminal module is fastened in the insulating housing. The terminal module includes a plurality of corrosion resistance terminals. Each corrosion resistance terminal has a fastening portion. A front end of the fastening portion extends frontward to form a contacting portion. A rear end of the fastening portion defines a soldering portion. A surface of the contacting portion of each corrosion resistance terminal sequentially has a copper electroplating layer, a nickel-tungsten electroplating layer, a gold electroplating layer, a platinum alloy electroplating layer and a rhodium-ruthenium alloy electroplating layer from an inside to an outside. The copper electroplating layer is covered on the surface of the contacting portion, the nickel-tungsten electroplating layer is covered on a surface of the copper electroplating layer, the gold electroplating layer is covered on a surface of the nickel-tungsten electroplating layer, the platinum alloy electroplating layer is covered on a surface of the gold electroplating layer, the rhodium-ruthenium alloy electroplating layer is covered on a surface of the platinum alloy electroplating layer. A surface of the fastening portion of each corrosion resistance terminal is covered with an electro-deposition coating.

Another object of the present invention is to provide a corrosion resistance terminal. The corrosion resistance terminal has a fastening portion and a contacting portion. A surface of the fastening portion is covered with an electro-deposition coating. A front end of the fastening portion extends frontward to form the contacting portion. A surface of the contacting portion sequentially has a copper electroplating layer, a nickel-tungsten electroplating layer, a gold electroplating layer, a platinum alloy electroplating layer and a rhodium-ruthenium alloy electroplating layer from an inside to an outside. The copper electroplating layer is covered on the surface of the contacting portion, the nickel-tungsten electroplating layer is covered on a surface of the copper electroplating layer, the gold electroplating layer is covered on a surface of the nickel-tungsten electroplating layer, the platinum alloy electroplating layer is covered on a surface of the gold electroplating layer, the rhodium-ruthenium alloy electroplating layer is covered on a surface of the platinum alloy electroplating layer.

Another object of the present invention is to provide an electrical connector. The electrical connector includes an insulating housing, an upper terminal assembly and a lower terminal assembly. The upper terminal assembly is fastened in the insulating housing. The upper terminal assembly includes a plurality of upper terminals and an upper base body. The plurality of the upper terminals are fastened in the upper base body. Each upper terminal has an upper fastening portion, an upper contacting portion and an upper soldering portion. A front end of the upper fastening portion extends frontward to form the upper contacting portion. A rear end of the upper fastening portion extends rearward, then extends downward and is further bent rearward to form the upper soldering portion. The upper fastening portion has an electro-deposition coating. A surface of the upper contacting portion sequentially has a copper electroplating layer, a nickel-tungsten electroplating layer, a gold electroplating layer, a platinum alloy electroplating layer and a rhodium-ruthenium alloy electroplating layer from an inside to an outside. The copper electroplating layer is covered on the surface of the upper contacting portion, the nickel-tungsten electroplating layer is covered on a surface of the copper electroplating layer, the gold electroplating layer is covered on a surface of the nickel-tungsten electroplating layer, the platinum alloy electroplating layer is covered on a surface of the gold electroplating layer, the rhodium-ruthenium alloy electroplating layer is covered on a surface of the platinum alloy electroplating layer. The lower terminal assembly is fastened in the insulating housing. The upper terminal assembly is mounted on the lower terminal assembly. The lower terminal assembly includes a plurality of lower terminals and a lower base body. The plurality of the lower terminals are fastened in the lower base body. Each lower terminal has a lower fastening portion, a lower contacting portion and a lower soldering portion. A front end of the lower fastening portion extends frontward to form the lower contacting portion. A rear end of the lower fastening portion extends rearward, then extends downward and is further bent frontward to form the lower soldering portion. The lower fastening portion has the electro-deposition coating. A surface of the lower contacting portion sequentially has the copper electroplating layer, the nickel-tungsten electroplating layer, the gold electroplating layer, the platinum alloy electroplating layer and the rhodium-ruthenium alloy electroplating layer from the inside to the outside. The copper electroplating layer is covered on the surface of the lower contacting portion, the nickel-tungsten electroplating layer is covered on the surface of the copper electroplating layer, the gold electroplating layer is covered on the surface of the nickel-tungsten electroplating layer, the platinum alloy electroplating layer is covered on the surface of the gold electroplating layer, the rhodium-ruthenium alloy electroplating layer is covered on the surface of the platinum alloy electroplating layer.

As described above, each contacting portion of the corrosion resistance terminal of the electrical connector has the copper electroplating layer, the nickel-tungsten electroplating layer, the gold electroplating layer, the platinum alloy electroplating layer and the rhodium-ruthenium alloy electroplating layer in sequence, so each contacting portion of the corrosion resistance terminal of the electrical connector is designed to have five electroplating layers. Each fastening portion of the corrosion resistance terminal is surrounded by the electro-deposition coating, and the electro-deposition coating is non-conductive. As a result, the electrical connector and the corrosion resistance terminal have a corrosion resistance performance which lasts longer time, the electrical connector and the corrosion resistance terminal have lower costs, and each fastening portion of the corrosion resistance terminal which is a non-contact area of the corrosion resistance terminal of the electrical connector also has the corrosion resistance performance.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with a preferred embodiment of the present invention;

FIG. 2 is another perspective view of the electrical connector of FIG. 1;

FIG. 3 is an exploded view of the electrical connector of FIG. 1;

FIG. 4 is another exploded view of the electrical connector of FIG. 1;

FIG. 5 is a partially exploded view of the electrical connector of FIG. 1;

FIG. 6 is another partially exploded view of the electrical connector of FIG. 1;

FIG. 7 is a partial perspective view of the electrical connector of FIG. 1, wherein a center grounding plate, an upper terminal assembly and a lower terminal assembly of a terminal module are separated;

FIG. 8 is another partial perspective view of the electrical connector of FIG. 1, wherein the center grounding plate, the upper terminal assembly and the lower terminal assembly of the terminal module are separated;

FIG. 9 is a perspective view of the center grounding plate of the electrical connector of FIG. 1;

FIG. 10 is a diagrammatic drawing of electroplating layers of a contacting portion of a corrosion resistance terminal in accordance with the present invention; and

FIG. 11 is a diagrammatic drawing of an electro-deposition coating of a fastening portion of the corrosion resistance terminal in accordance with the present invention.

### DETAILED DESCRIPTION OF THE PREFERRED EMBODIMENT

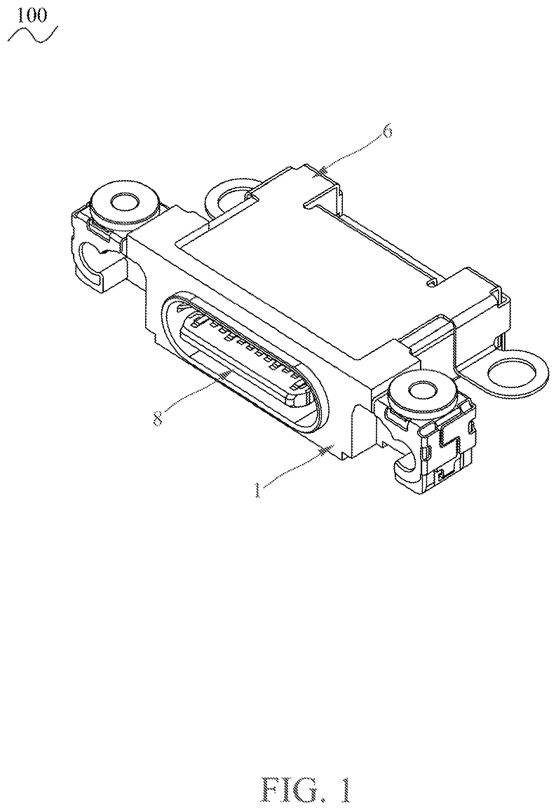

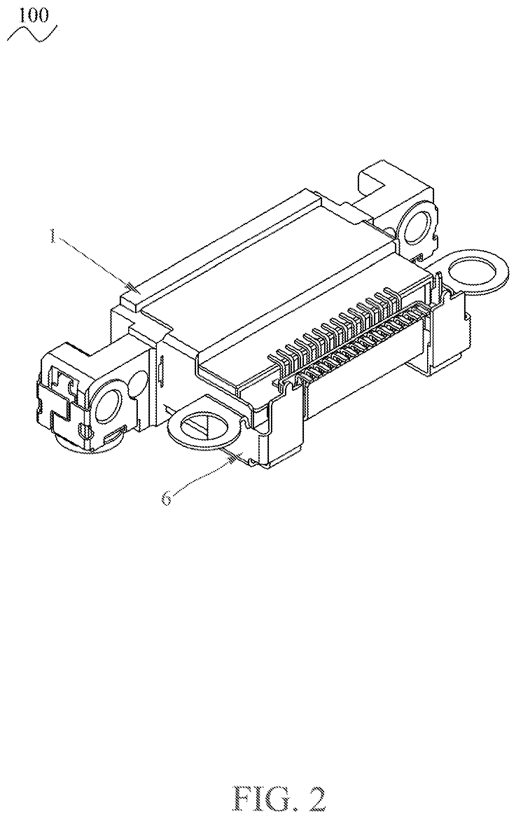

With reference to FIG. 1 to FIG. 4, an electrical connector 100 and a corrosion resistance terminal 23 in accordance with a preferred embodiment of the present invention are shown. The electrical connector 100 includes an insulation body 1, a terminal module 2, a center grounding plate 3, an insulating housing 4, two grounding elements 5, a metal shell assembly 6, a glue body 7 and a docking element 8. In the preferred embodiment, the electrical connector 100 is a TYPE-C electrical connector. In another specific embodiment of the present invention, the electrical connector 100 is another type electrical connector which is different from the TYPE-C electrical connector.

The terminal module 2 is fastened in the insulating housing 4. The center grounding plate 3 is mounted in a middle of the terminal module 2, and the terminal module 2 and the center grounding plate 3 are fastened in the insulating housing 4. The insulating housing 4 surrounds the center grounding plate 3 and the terminal module 2. The insulating housing 4 is fastened in the insulation body 1. The two grounding elements are disposed to a top surface and a bottom surface of the insulating housing 4. The metal shell assembly 6 are disposed to a top surface and a bottom surface of the insulation body 1. The metal shell assembly 6 is used for grounding and shielding an electrical interference.

The glue body 7 is mounted to a rear end of the insulating housing 4. The glue body 7 is covered to a rear end of the insulation body 1. The glue body 7 seals up a gap between the insulating housing 4 and the insulation body 1, so that water is prevented from flowing into a rear end of the electrical connector 100, and the electrical connector 100 is prevented from being damaged due to a water infiltration of the electrical connector 100. In the preferred embodiment, the metal shell assembly 6 includes an upper metal shell 61 and a lower metal shell 62. The upper metal shell 61 and the lower metal shell 62 of the metal shell assembly 6 are soldered to the rear end of the insulation body 1.

The insulation body 1 has a docking groove 10, two hollow assembling sections 11 and a receiving cavity 12. A front end of the insulation body 1 defines the docking groove 10 longitudinally penetrating through a middle of a front surface of the insulation body 1. The docking groove 10 is used for docking with another electrical connector (not shown). In the preferred embodiment, two sides of a middle of the insulation body 1 form the two hollow assembling sections 11. Two corresponding mechanisms of the metal shell assembly 6 are fastened in the two assembling sections 11, so that the metal shell assembly 6 is located to the insulation body 1, and the metal shell assembly 6 is fastened to the insulation body 1. An inside the insulation body 1 forms the receiving cavity 12 penetrating through a rear surface of the insulation body 1. The terminal module 2 is received in the receiving cavity 12, so that the terminal module 2 is located to the insulation body 1, and the terminal module 2 is fastened to the insulation body 1.

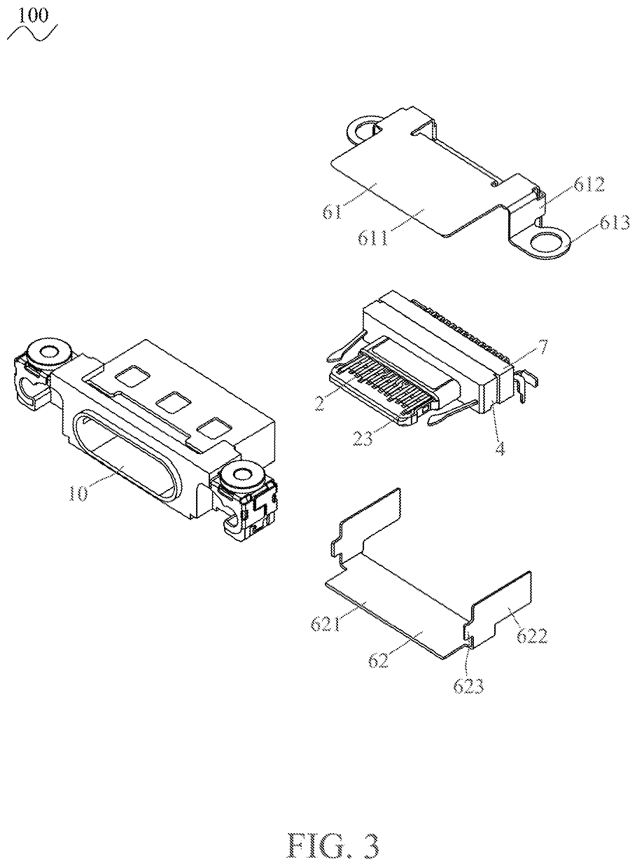

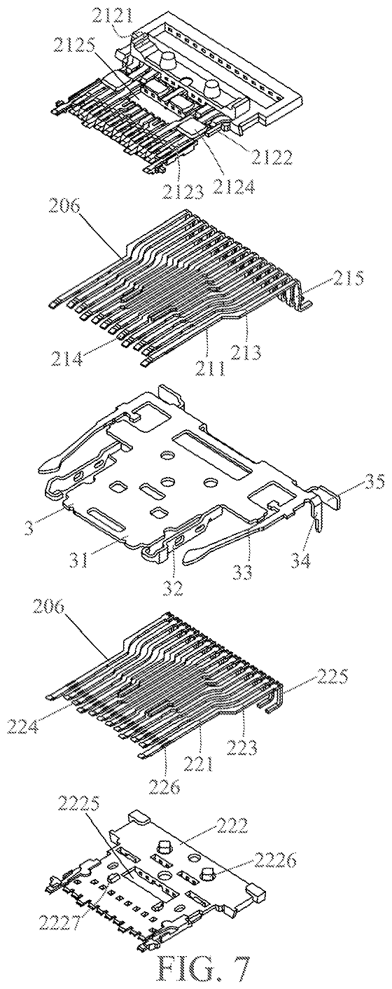

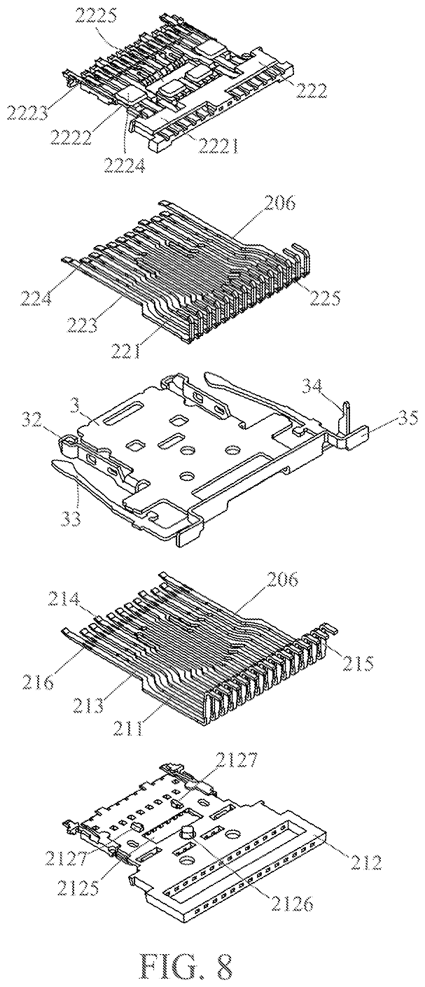

Referring to FIG. 3 to FIG. 8, the terminal module 2 is arranged in the insulating housing 4. The terminal module 2 includes an upper terminal assembly 21 fastened in the insulating housing 4, and a lower terminal assembly 22 fastened in the insulating housing 4. The upper terminal assembly 21 is mounted on the lower terminal assembly 22. The center grounding plate 3 is positioned between the upper terminal assembly 21 and the lower terminal assembly 22. The terminal module 2 includes a plurality of the corrosion resistance terminals 23. The plurality of the corrosion resistance terminals 23 are mounted in the insulation body 1. Each corrosion resistance terminal 23 has a fastening portion 231, a contacting portion 232 and a soldering portion 233. A front end of the fastening portion 231 extends frontward to form the contacting portion 232. A rear end of the fastening portion 231 defines the soldering portion 233.

The upper terminal assembly 21 includes a plurality of upper terminals 211 and an upper base body 212. The plurality of the upper terminals 211 are arranged in an upper row. The plurality of the upper terminals 211 are fastened in the upper base body 212. Each upper terminal 211 has an upper fastening portion 213, an upper contacting portion 214 and an upper soldering portion 215. The upper fastening portion 213 is disposed horizontally. A front end of the upper fastening portion 213 extends frontward to form the upper contacting portion 214. A rear end of the upper fastening portion 213 extends rearward, then extends downward and is further bent rearward to form the upper soldering portion 215. Two opposite sides of a bottom surface of the upper contacting portion 214 have two upper chamfers 216 slantwise extending downward and outward. Each upper chamfer 216 is used for reducing a degumming risk of the upper terminal assembly 21 to reinforce an impact resistance performance.

The upper base body 212 has an upper main body 2121. A middle of a front surface of the upper main body 2121 extends frontward to form an upper extending portion 2122. A front end of the upper extending portion 2122 extends frontward to form an upper tongue portion 2123. The upper fastening portions 213 of the plurality of the upper terminals 211 are fastened in the upper main body 2121 and the upper extending portion 2122 of the upper base body 212, and the upper fastening portions 213 of the plurality of the upper terminals 211 are surrounded by the upper main body 2121 of the upper base body 212. The upper contacting portions 214 of the plurality of the upper terminals 211 are fastened in the upper tongue portion 2123 of the upper base body 212, and the upper contacting portions 214 of the plurality of the upper terminals 211 are surrounded by the upper tongue portion 2123 of the upper base body 212. The upper soldering portions 215 of the plurality of the upper terminals 211 project beyond a rear surface of the upper main body 2121 of the upper base body 212.

Several portions of a top surface of the upper extending portion 2122 extend upward to form a plurality of upper supporting portions 2124. When the insulating housing 4 is formed, the plurality of the upper supporting portions 2124 are used for supporting corresponding positions of the one grounding element 5 to avoid an encapsulation problem of the one grounding element 5. A middle of the upper base body 212 has an upper hollow portion 2125 penetrating through a top surface and a bottom surface of the upper base body 212. The upper hollow portion 2125 is formed between the upper extending portion 2122 and the upper tongue portion 2123. When the upper base body 212 and the insulating housing 4 are molded by an injection molding technology, the upper hollow portion 2125 is used for avoiding the plurality of the upper terminals 211 from being deformed.

When the insulating housing 4 is molded, the upper hollow portion 2125 is filled up to improve a bond between a primary molding and a secondary molding. A middle of the bottom surface of the upper base body 212 extends downward to form an upper location foot 2126. The upper location foot 2126 is corresponding to a corresponding portion of the center grounding plate 3, so that the center grounding plate 3 is located to the upper terminal assembly 21, and the center grounding plate 3 is fixed to the upper terminal assembly 21. Several portions of a bottom surface of the upper tongue portion 2123 of the upper base body 212 extend downward to form a plurality of upper protruding blocks 2127. The plurality of the upper protruding blocks 2127 are used for being buckled with corresponding sections of the center grounding plate 3, so that the center grounding plate 3 is located to the upper terminal assembly 21, and the center grounding plate 3 is fixed to the upper terminal assembly 21.

The lower terminal assembly 22 is matched with the upper terminal assembly 21. A structure of the lower terminal assembly 22 is approximately the same as a structure of the upper terminal assembly 21. The lower terminal assembly 22 includes a plurality of lower terminals 221 and a lower base body 222. The plurality of the lower terminals 221 are arranged in a lower row. The plurality of the lower terminals 221 are fastened in the lower base body 222. Each lower terminal 221 has a lower fastening portion 223, a lower contacting portion 224 and a lower soldering portion 225. The lower fastening portion 223 is disposed horizontally. A front end of the lower fastening portion 223 extends frontward to form the lower contacting portion 224. A rear end of the lower fastening portion 223 extends rearward, then extends downward and is further bent frontward to form the lower soldering portion 225. Two opposite sides of a top surface of the lower contacting portion 224 have two lower chamfers 226 slantwise extending upward and outward. Each lower chamfer 226 is used for reducing a degumming risk of the lower terminal assembly 22 to reinforce the impact resistance performance.

The lower base body 222 has a lower main body 2221. A middle of a front surface of the lower main body 2221 extends frontward to form a lower extending portion 2222. A front end of the lower extending portion 2222 extends frontward to form a lower tongue portion 2223. The lower fastening portions 223 of the plurality of the lower terminals 221 are fastened in the lower main body 2221 and the lower extending portion 2222 of the lower base body 222, and the lower fastening portions 223 of the plurality of the lower terminals 221 are surrounded by the lower main body 2221 of the lower base body 222. The lower contacting portions 224 of the plurality of the lower terminals 221 are fastened in the lower tongue portion 2223 of the lower base body 222, and the lower contacting portions 224 of the plurality of the lower terminals 221 are surrounded by the lower tongue portion 2223 of the lower base body 222. The lower soldering portions 225 of the plurality of the lower terminals 221 project beyond a rear end of the lower base body 222. The lower soldering portions 225 of the plurality of the lower terminals 221 project beyond a rear surface of the lower main body 2221 of the lower base body 222.

Several portions of a bottom surface of the lower extending portion 2222 extend downward to form a plurality of lower supporting portions 2224. When the insulating housing 4 is formed, the plurality of the lower supporting portions 2224 are used for supporting corresponding mechanisms of the other grounding element 5 to avoid an encapsulation problem of the other grounding element 5. The lower base body 222 has a lower hollow portion 2225 penetrating through a top surface and a bottom surface of the lower base body 222. The lower hollow portion 2225 is formed between the lower extending portion 2222 and the lower tongue portion 2223. When the lower base body 222 and the insulating housing 4 are molded by the injection molding technology, the lower hollow portion 2225 is used for avoiding the plurality of the lower terminals 221 from being deformed.

When the insulating housing 4 is molded, the lower hollow portion 2225 is filled up to improve the bond between the primary molding and the secondary molding. The top surface of the lower base body 222 extends upward to form a lower location foot 2226. Two sides of the top surface of the lower base body 222 extend upward to form two lower location feet 2226. The lower location foot 2226 is corresponding to a corresponding segment of the center grounding plate 3, so that the center grounding plate 3 is located to the lower terminal assembly 22, and the center grounding plate 3 is fixed to the lower terminal assembly 22. Several portions of a top surface of the lower tongue portion 2223 of the lower base body 222 extend upward to form a plurality of lower protruding blocks 2227. The plurality of the lower protruding blocks 2227 are used for being buckled with corresponding areas of the center grounding plate 3, so that the center grounding plate 3 is located to the lower terminal assembly 22, and the center grounding plate 3 is fixed to the lower terminal assembly 22.

In the preferred embodiment, the plurality of the upper terminals 211 and the plurality of the lower terminals 221 are defined as the plurality of the corrosion resistance terminals 23. Each of the upper fastening portions 213 of the plurality of the upper terminals 211 and the lower fastening portions 223 of the plurality of the lower terminals 221 is defined as the fastening portion 231. Each of the upper contacting portions 214 of the plurality of the upper terminals 211 and the lower contacting portions 224 of the plurality of the lower terminals 221 is defined as the contacting portion 232. Each of the upper soldering portions 215 of the plurality of the upper terminals 211 and the lower soldering portions 225 of the plurality of the lower terminals 221 is defined as the soldering portion 233.

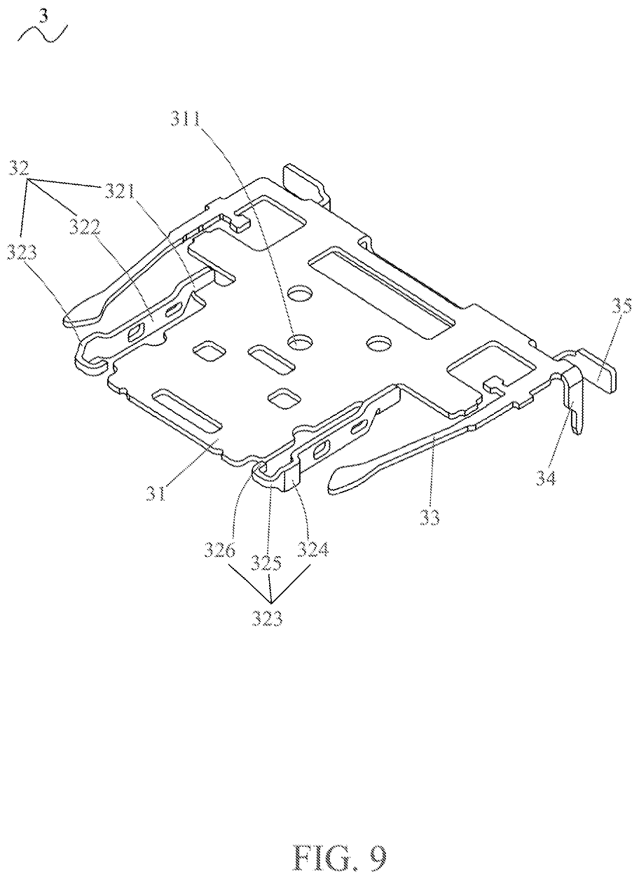

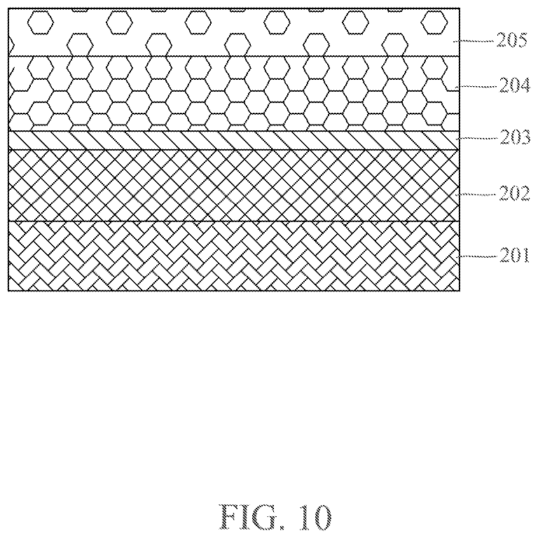

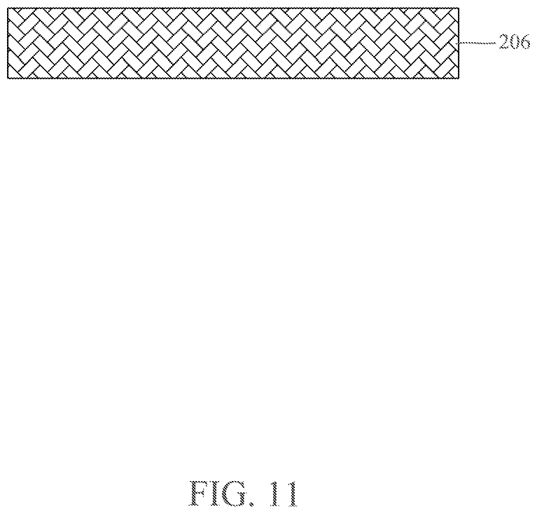

Referring to FIG. 1 to FIG. 11, in order to prevent the corrosion resistance terminal 23 from being corroded, especially, in order to prevent the contacting portion 232 of the corrosion resistance terminal 23 from being corroded, a surface of the contacting portion 232 of each corrosion resistance terminal 23 sequentially has a copper electroplating layer 201, a nickel-tungsten electroplating layer 202, a gold electroplating layer 203, a platinum alloy electroplating layer 204 and a rhodium-ruthenium alloy electroplating layer 205 from an inside to an outside.

A surface of the fastening portion 231 of each corrosion resistance terminal 23 uses an electro-deposition coating 206. The surface of the fastening portion 231 of each corrosion resistance terminal 23 is covered with the electro-deposition coating 206. The electro-deposition coating 206 is non-conductive. The electro-deposition coating 206 surrounds the surface of the fastening portion 231 of each corrosion resistance terminal 23 for improving a corrosion resistance performance. In the preferred embodiment, a thickness of the electro-deposition coating 206 is more than 0.01 millimeter and is less than 0.02 millimeters. The electro-deposition coating 206 includes titanium dioxide and an acrylic resin coating. In the preferred embodiment, each corrosion resistance terminal 23 is stamped to be manufactured in advance. Then the contacting portion 232 of each corrosion resistance terminal 23 is electroplated by the copper electroplating layer 201, the nickel-tungsten electroplating layer 202, the gold electroplating layer 203, the platinum alloy electroplating layer 204 and the rhodium-ruthenium alloy electroplating layer 205 in sequence. Finally, the fastening portion 231 of each corrosion resistance terminal 23 is electroplated by the electro-deposition coating 206.

The copper electroplating layer 201 is covered on the surface of the contacting portion 232 of each corrosion resistance terminal 23. The copper electroplating layer 201 is defined as a base layer. The copper electroplating layer 201 is closely combined with the surface of the corrosion resistance terminal 23, and the copper electroplating layer 201 makes the surface of the corrosion resistance terminal 23 smoother to improve a binding force between the corrosion resistance terminal 23 and other electroplating layers. In the preferred embodiment, a thickness of the copper electroplating layer 201 is more than 1 micron and is less than 3 microns.

The nickel-tungsten electroplating layer 202 is covered on a surface of the copper electroplating layer 201. The nickel-tungsten electroplating layer 202 has the better corrosion resistance performance to improve the corrosion resistance performance of the corrosion resistance terminal 23. In the preferred embodiment, a thickness of the nickel-tungsten electroplating layer 202 is more than 1 micron and is less than 2 microns.

The gold electroplating layer 203 is covered on a surface of the nickel-tungsten electroplating layer 202. The gold electroplating layer 203 is used for improving a binding force between the nickel-tungsten electroplating layer 202 and the platinum alloy electroplating layer 204. In the preferred embodiment, a thickness of the gold electroplating layer 203 is 0.1 micron.

The platinum alloy electroplating layer 204 is covered on a surface of the gold electroplating layer 203. The platinum alloy electroplating layer 204 has the better corrosion resistance performance to improve the corrosion resistance performance of the corrosion resistance terminal 23. In the preferred embodiment, a thickness of the platinum alloy electroplating layer 204 is more than 2 microns and is less than 2.5 microns.

The rhodium-ruthenium alloy electroplating layer 205 is covered on a surface of the platinum alloy electroplating layer 204. The rhodium-ruthenium alloy electroplating layer 205 has the better corrosion resistance performance and an abrasion resistance performance to improve the corrosion resistance performance and the abrasion resistance performance of the corrosion resistance terminal 23. In the preferred embodiment, a thickness of the rhodium-ruthenium alloy electroplating layer 205 is more than 0.8 microns and is less than 1 micron.

The upper fastening portion 213 has the electro-deposition coating 206. A surface of the upper contacting portion 214 sequentially has the copper electroplating layer 201, the nickel-tungsten electroplating layer 202, the gold electroplating layer 203, the platinum alloy electroplating layer 204 and the rhodium-ruthenium alloy electroplating layer 205 from the inside to the outside. The copper electroplating layer 201 is covered on the surface of the upper contacting portion 214, the nickel-tungsten electroplating layer 202 is covered on the surface of the copper electroplating layer 201, the gold electroplating layer 203 is covered on the surface of the nickel-tungsten electroplating layer 202, the platinum alloy electroplating layer 204 is covered on the surface of the gold electroplating layer 203, the rhodium-ruthenium alloy electroplating layer 205 is covered on the surface of the platinum alloy electroplating layer 204.

The lower fastening portion 213 has the electro-deposition coating 206. A surface of the lower contacting portion 224 sequentially has the copper electroplating layer 201, the nickel-tungsten electroplating layer 202, the gold electroplating layer 203, the platinum alloy electroplating layer 204 and the rhodium-ruthenium alloy electroplating layer 205 from the inside to the outside. The copper electroplating layer 201 is covered on the surface of the lower contacting portion, the nickel-tungsten electroplating layer 202 is covered on the surface of the copper electroplating layer 201, the gold electroplating layer 203 is covered on the surface of the nickel-tungsten electroplating layer 202, the platinum alloy electroplating layer 204 is covered on the surface of the gold electroplating layer 203, the rhodium-ruthenium alloy electroplating layer 205 is covered on the surface of the platinum alloy electroplating layer 204.

Referring to FIG. 1 to FIG. 9, the center grounding plate 3 has a base plate 31, two first bending arms 32, two elastic arms 33, two soldering feet 34 and two second bending arms 35. The base plate 31 has a plurality of positioning holes 311. The plurality of the positioning holes 311 vertically penetrate through a top surface and a bottom surface of base plate 31. The upper location foot 2126 of the upper base body 212 and the two lower location feet 2226 of the lower base body 222 are fastened in the plurality of the positioning holes 311 of the base plate 31 of the center grounding plate 3, so that the center grounding plate 3 is located to the upper terminal assembly 21 and the lower terminal assembly 22, and the center grounding plate 3 is fixed to the upper terminal assembly 21 and the lower terminal assembly 22.

Two opposite sides of a middle of the base plate 31 are bent upward, then extend frontward and are further curved oppositely to form the two first bending arms 32, respectively. Two opposite sides of a rear end of the base plate 31 extend frontward to form the two elastic arms 33, respectively. When the two elastic arms 33 are connected with another electrical connector (not shown), the two elastic arms 33 are used for providing an insertion and withdrawal force. Each first bending arm 32 is disposed between the base plate 31 and one elastic arm 33. Two opposite sides of the rear end of the base plate 31 extend downward to form the two soldering feet 34. Each elastic arm 33 is disposed between one first bending arm 32 and one soldering foot 34. In the preferred embodiment, the two first bending arms 32 are mirrored with respect to the center grounding plate 3. The two elastic arms 33 are mirrored with respect to the center grounding plate 3. The two soldering feet 34 are mirrored with respect to the center grounding plate 3.

Each first bending arm 32 has a bending portion 321, an extending arm 322 and a hook portion 323. The bending portion 321 is perpendicularly bent upward from an outer side of the middle of the base plate 31. A front end of the bending portion 321 slantwise extends frontward and downward, and then extends frontward to form the extending arm 322. A front end of the extending arm 322 is arched outward, then extends inward and is further bent rearward to form the hook portion 323.

The hook portion 323 has a first bending section 324, a second bending section 325 and a third bending section 326. The first bending section 324 is arched outward from the front end of the extending arm 322. The second bending section 325 is extended inward and towards the base plate 31 of the center grounding plate 3 from a front end of the first bending section 324. The third bending section 326 is bent rearward from a free end of the second bending section 325.

The center grounding plate 3 is received between the insulating housing 4 and the docking element 8. The bending portion 321 is received in the insulating housing 4. The two extending arms 322 are partially received in the insulating housing 4. The two extending arms 322 are partially exposed to two sides of the insulating housing 4. The two first bending sections 324 of the two first bending arms 32 are exposed to the two sides of the insulating housing 4. The two second bending sections 325 and the two third bending sections 326 of the two first bending arms 32 are fastened in the docking element 8, so that the center grounding plate 3 is located to the docking element 8, and the center grounding plate 3 is fixed to the docking element 8. The docking element 8 is fastened in a front end of the insulating housing 4.

The first bending section 324, the second bending section 325 and the third bending section 326 together form the hook portion 323 for reinforcing a structure strength of the center grounding plate 3 of the electrical connector 100 so as to enhance a structure strength of the electrical connector 100. The bending portion 321, the extending arm 322 and the hook portion 323 form the first bending arm 32. The first bending arm 32 is perpendicularly extended upward. The two bending portions 321 of the two first bending arms 32 are received in the insulating housing 4, and the two extending arms 322 of the two first bending arms 32 are partially received in the insulating housing 4. The two extending arms 322 of the two first bending arms 32 are partially exposed to the insulating housing 4, and the two first bending sections 324 of the two first bending arms 32 are exposed to the insulating housing 4. The two second bending sections 325 and the two third bending sections 326 of the two first bending arms 32 are fastened in the docking element 8 to reinforce the structure strength of the electrical connector 100.

The two opposite sides of the rear end of the base plate 31 extend rearward and then are bent outward to form the two second bending arms 35. The two second bending arms 35 are connected with corresponding locations of the metal shell assembly 6, so that the center grounding plate 3 is located to the metal shell assembly 6, and the center grounding plate 3 is fixed to the metal shell assembly 6.

Referring to FIG. 3 to FIG. 6, the insulating housing 4 has a main portion 41, a stepping portion 42 and a plurality of through holes 43. A middle of a front end of the main portion 41 extends frontward to the stepping portion 42. The plurality of the through holes 43 penetrate though a top surface and a bottom surface of the stepping portion 42. The upper supporting portions 2124 of the upper terminal assembly 21 and the lower supporting portions 2224 of the lower terminal assembly 22 are fastened in the plurality of the through holes 43. When the insulating housing 4 is formed, the two grounding elements 5 are avoided from causing the encapsulation problem.

The upper main body 2121 of the upper base body 212 and the lower main body 2221 of the lower base body 222 are disposed in the main portion 41 of the insulating housing 4. The upper extending portion 2122 of the upper base body 212 and the lower extending portion 2222 of the lower base body 222 are disposed in the stepping portion 42 of the insulating housing 4. The upper hollow portion 2125 of the upper base body 212 and the lower hollow portion 2225 of the lower base body 222 are filled by the insulating housing 4, so that the terminal module 2 is located to the insulating housing 4, and the terminal module 2 is fixed to the insulating housing 4.

In the preferred embodiment, the upper terminal assembly 21, the lower terminal assembly 22 and the center grounding plate 3 are manufactured in advance. Then the upper terminal assembly 21, the lower terminal assembly 22 and the center grounding plate 3 are assembled together, so that the center grounding plate 3 is positioned between the upper terminal assembly 21 and the lower terminal assembly 22. Finally, the insulating housing 4 is molded to the upper terminal assembly 21, the lower terminal assembly 22 and the center grounding plate 3 by the injection molding technology. The insulating housing 4 surrounds the upper terminal assembly 21, the center grounding plate 3 and the lower terminal assembly 22.

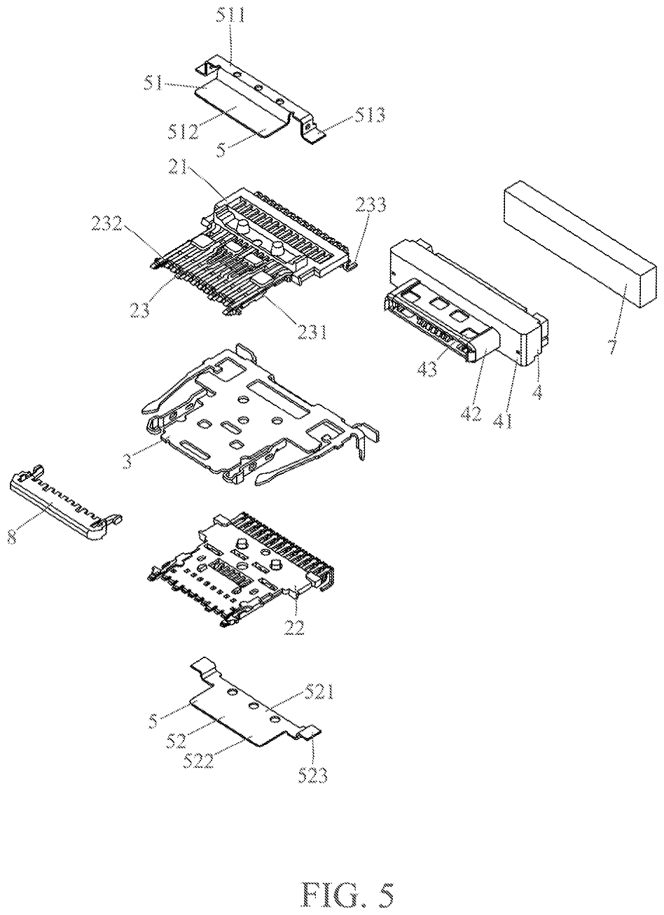

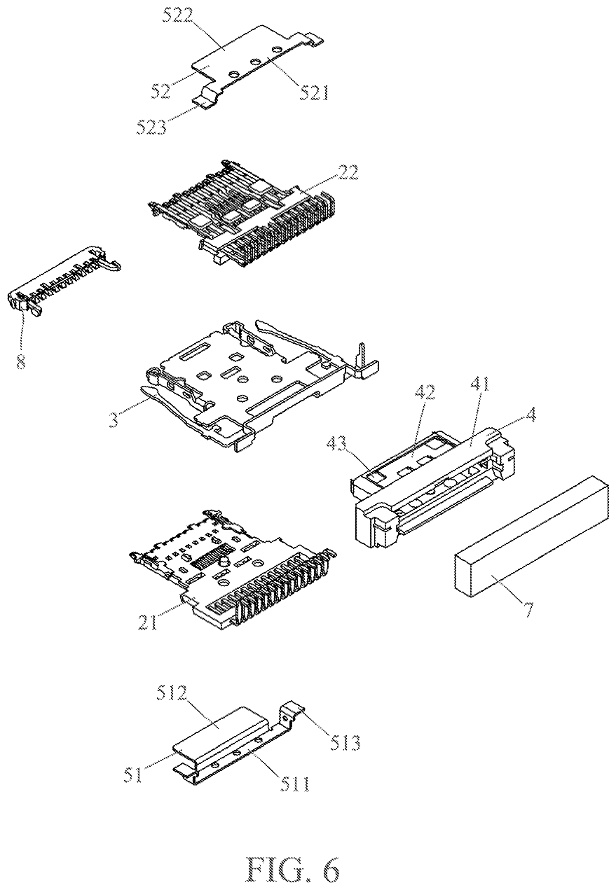

Referring to FIG. 5 and FIG. 6, each grounding element 5 includes an upper shielding plate 51 and a lower shielding plate 52. The upper shielding plate 51 is disposed to a top surface of the insulating housing 4. The lower shielding plate 52 is disposed to the bottom surface of the insulating housing 4. The lower shielding plate 52 and the upper shielding plate 51 are disposed opposite to each other. The upper shielding plate 51 is symmetrical to the lower shielding plate 52 with respect to the center grounding plate 3. The upper shielding plate 51 is disposed above the upper fastening portions 213 of the plurality of the upper terminals 211, and the lower shielding plate 52 is disposed under the lower fastening portions 223 of the plurality of the lower terminals 221. In the preferred embodiment, the upper shielding plate 51 is soldered to a top surface of the center grounding plate 3, and the lower shielding plate 52 is soldered to a bottom surface of the center grounding plate 3.

The upper shielding plate 51 has an upper fastening plate 511, an upper connecting plate 512, two upper soldering pieces 513. The upper fastening plate 511 is surrounded by the main portion 41 of the insulating housing 4. A middle of a front end of the upper fastening plate 511 is bent downward and then extends frontward to form the upper connecting plate 512. The upper connecting plate 512 is exposed outside to a top surface of the stepping portion 42 of the insulating housing 4. Two opposite sides of the upper fastening plate 511 are bent downward and then extend outward to form the two upper soldering pieces 513, respectively. The two upper soldering pieces 513 are soldered to two sides of the top surface of the base plate 31 of the center grounding plate 3.

The lower shielding plate 52 has a lower fastening plate 521, a lower connecting plate 522 and two lower soldering pieces 523. The lower fastening plate 521 is surrounded by the main portion 41 of the insulating housing 4. A middle of a front end of the lower fastening plate 521 extends frontward to form the lower connecting plate 522. The lower connecting plate 522 is exposed outside to a bottom surface of the stepping portion 42 of the insulating housing 4. Two opposite sides of the lower fastening plate 521 are bent upward and then extend outward to form the two lower soldering pieces 523, respectively. The two lower soldering pieces 523 are soldered to two sides of the bottom surface of the base plate 31 of the center grounding plate 3.

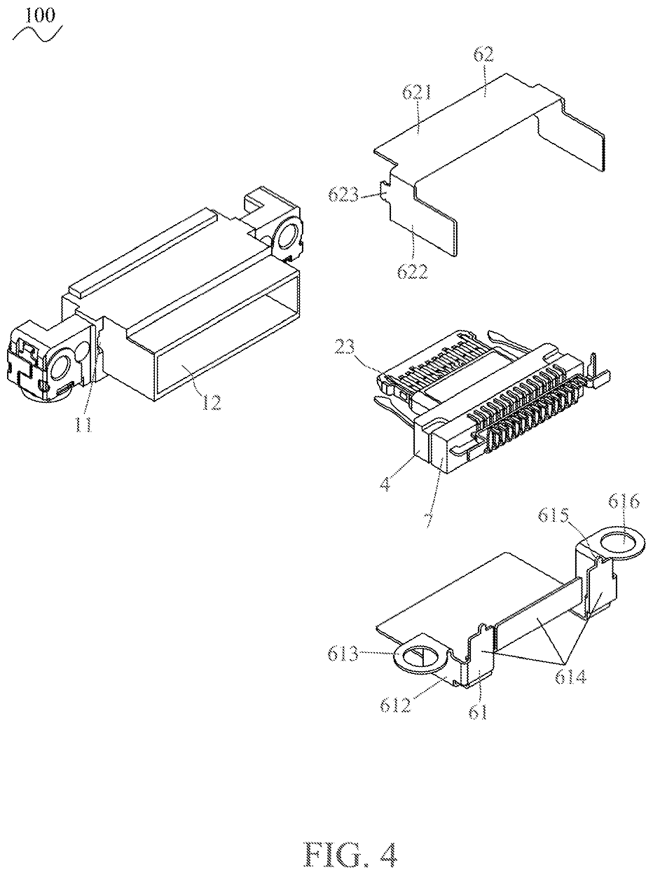

Referring to FIG. 3 and FIG. 4, the upper metal shell 61 is connected to the lower metal shell 62 by a spot welding technology. The upper metal shell 61 has an upper covering plate 611, two upper blocking plates 612, two upper wings 613, a rear plate 614, two grounding slices 615 and two positioning perforations 616. In the preferred embodiment, the upper metal shell 61 has the two grounding slices 615. Two sides of the upper covering plate 611 extend downward to form the two upper blocking plates 612. Two bottoms of the two upper blocking plates 612 oppositely extend outward to form the two upper wings 613. A rear of the upper covering plate 611 extends downward to form the rear plate 614. The rear plate 614 shields a part of the glue body 7. Two sides of a lower edge of the rear plate 614 extend downward to form the two grounding slices 615. The two upper wings 613 define the two positioning perforations 616. Each positioning perforation 616 is shown as a circular shape.

The lower metal shell 62 has a lower covering plate 621, two lower blocking plates 622 and two buckling portions 623. Two sides of the lower covering plate 621 are bent upward and then extend rearward to form the two lower blocking plates 622. Two front ends of the two lower blocking plates 622 protrude frontward and towards the insulation body 1 to form the two buckling portions 623. The two buckling portions 623 are buckled in the two assembling sections 11 of the insulation body 1, so that the metal shell assembly 6 is located to the insulation body 1, and the metal shell assembly 6 is fastened to the insulation body 1.

As described above, each contacting portion 232 of the corrosion resistance terminal 23 of the electrical connector 100 has the copper electroplating layer 201, the nickel-tungsten electroplating layer 202, the gold electroplating layer 203, the platinum alloy electroplating layer 204 and the rhodium-ruthenium alloy electroplating layer 205 in sequence, so each contacting portion 232 of the corrosion resistance terminal 23 of the electrical connector 100 is designed to have five electroplating layers. Each fastening portion 231 of the corrosion resistance terminal 23 is surrounded by the electro-deposition coating 206, and the electro-deposition coating 206 is non-conductive. As a result, the electrical connector 100 and the corrosion resistance terminal 23 have the corrosion resistance performance which lasts longer time, the electrical connector 100 and the corrosion resistance terminal 23 have lower costs, and each fastening portion 231 of the corrosion resistance terminal 23 which is a non-contact area of the corrosion resistance terminal 23 of the electrical connector 100 also has the corrosion resistance performance.

What is claimed is:

1. An electrical connector, comprising:
an insulating housing; and
a terminal module fastened in the insulating housing, the terminal module including a plurality of corrosion resistance terminals, each corrosion resistance terminal having a fastening portion, a front end of the fastening portion extending frontward to form a contacting portion, a rear end of the fastening portion defining a soldering portion, a surface of the contacting portion of each corrosion resistance terminal sequentially having a copper electroplating layer, a nickel-tungsten electroplating layer, a gold electroplating layer, a platinum alloy electroplating layer and a rhodium-ruthenium alloy electroplating layer from an inside to an outside, the copper electroplating layer being covered on the surface of the contacting portion, the nickel-tungsten electroplating layer being covered on a surface of the copper electroplating layer, the gold electroplating layer being covered on a surface of the nickel-tungsten electroplating layer, the platinum alloy electroplating layer being covered on a surface of the gold electroplating layer, the rhodium-ruthenium alloy electroplating layer being covered on a surface of the platinum alloy electroplating layer, a surface of the fastening portion of each corrosion resistance terminal being covered with an electro-deposition coating.

2. The electrical connector as claimed in claim 1, wherein a thickness of the copper electroplating layer is more than 1 micron and is less than 3 microns.

3. The electrical connector as claimed in claim 1, wherein a thickness of the nickel-tungsten electroplating layer is more than 1 micron and is less than 2 microns.

4. The electrical connector as claimed in claim 1, wherein a thickness of the gold electroplating layer is 0.1 micron.

5. The electrical connector as claimed in claim 1, wherein a thickness of the platinum alloy electroplating layer is more than 2 microns and is less than 2.5 microns.

6. The electrical connector as claimed in claim 1, wherein a thickness of the rhodium-ruthenium alloy electroplating layer is more than 0.8 microns and is less than 1 micron.

7. The electrical connector as claimed in claim 1, wherein the electro-deposition coating includes titanium dioxide and an acrylic resin coating.

8. The electrical connector as claimed in claim 1, wherein a thickness of the electro-deposition coating is more than 0.01 millimeter and is less than 0.02 millimeters.

9. The electrical connector as claimed in claim 1, wherein the electro-deposition coating is non-conductive.

10. A corrosion resistance terminal, comprising:
a fastening portion, a surface of the fastening portion being covered with an electro-deposition coating; and
a contacting portion, a front end of the fastening portion extending frontward to form the contacting portion, a surface of the contacting portion sequentially having a copper electroplating layer, a nickel-tungsten electroplating layer, a gold electroplating layer, a platinum alloy electroplating layer and a rhodium-ruthenium alloy electroplating layer from an inside to an outside, the copper electroplating layer being covered on the surface of the contacting portion, the nickel-tungsten electroplating layer being covered on a surface of the copper electroplating layer, the gold electroplating layer being covered on a surface of the nickel-tungsten electroplating layer, the platinum alloy electroplating layer being covered on a surface of the gold electroplating layer, the rhodium-ruthenium alloy electroplating layer being covered on a surface of the platinum alloy electroplating layer.

11. An electrical connector, comprising:
an insulating housing;
an upper terminal assembly fastened in the insulating housing, the upper terminal assembly including a plurality of upper terminals and an upper base body, the plurality of the upper terminals being fastened in the upper base body, each upper terminal having an upper fastening portion, an upper contacting portion and an upper soldering portion, a front end of the upper fastening portion extending frontward to form the upper contacting portion, a rear end of the upper fastening portion extending rearward, then extending downward and being further bent rearward to form the upper soldering portion, the upper fastening portion having an electro-deposition coating, a surface of the upper contacting portion sequentially having a copper electroplating layer, a nickel-tungsten electroplating layer, a gold electroplating layer, a platinum alloy electroplating layer and a rhodium-ruthenium alloy electroplating layer from an inside to an outside, the copper electroplating layer being covered on the surface of the upper contacting portion, the nickel-tungsten electroplating layer being covered on a surface of the copper electroplating layer, the gold electroplating layer being covered on a surface of the nickel-tungsten electroplating layer, the platinum alloy electroplating layer being covered on a surface of the gold electroplating layer, the rhodium-ruthenium alloy electroplating layer being covered on a surface of the platinum alloy electroplating layer; and
a lower terminal assembly fastened in the insulating housing, the upper terminal assembly being mounted on the lower terminal assembly, the lower terminal assembly including a plurality of lower terminals and a lower base body, the plurality of the lower terminals being fastened in the lower base body, each lower terminal having a lower fastening portion, a lower contacting portion and a lower soldering portion, a front end of the lower fastening portion extending frontward to form the lower contacting portion, a rear end of the lower fastening portion extending rearward, then extending downward and being further bent frontward to form the lower soldering portion, the lower fastening portion having the electro-deposition coating, a surface of the lower contacting portion sequentially having the copper electroplating layer, the nickel-tungsten electroplating layer, the gold electroplating layer, the platinum alloy electroplating layer and the rhodium-ruthenium alloy electroplating layer from the inside to the outside, the copper electroplating layer being covered on the surface of the lower contacting portion, the nickel-tungsten electroplating layer being covered on the surface of the copper electroplating layer, the gold electroplating layer being covered on the surface of the nickel-tungsten electroplating layer, the platinum alloy electroplating layer being covered on the surface of the gold electroplating layer, the rhodium-ruthenium alloy electroplating layer being covered on the surface of the platinum alloy electroplating layer.
